(19) United States
(12) Patent Application Publication
(10) Pub. No.: US 2023/0354828 A1
(43) Pub. Date: Nov. 9, 2023

(54) Shape Generating Cupcake Pan Assembly

(71) Applicant: Debra Linehan, Antioch, TN (US)

(72) Inventor: Debra Linehan, Antioch, TN (US)

(21) Appl. No.: 17/737,555

(22) Filed: May 5, 2022

(51) Int. Cl. A21B 3/13; A21D 8/06; A21D 8/08

(52) U.S. Cl. CPC A21B 3/132; A21D 8/06; A21D 8/08

(57) ABSTRACT

A shape generating cupcake pan assembly for creating baked goods having a variety of shapes includes a tray and a plurality of molds. A plurality of holes is positioned in the tray. Each mold comprises a disc in which a recess is positioned. Each recess has a respective shape so that the plurality of molds comprises recesses having a variety of shapes. A lip, which extends radially from the disc, is complementary to a perimeter of a respective hole. The mold is removably engageable to the tray upon insertion into the respective hole. Upon addition of a baking mixture to the recess and baking, a baked good shaped complementarily to the recess is obtained.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cupcake pan assemblies and more particularly pertains to a new cupcake pan assembly for creating baked goods having a variety of shapes.

### (2) Description of Related Art Including Information Disclosed Under 37 CFR 1.97 and 1.98

The prior art relates to cupcake pan assemblies. Prior art cupcake pan assemblies for cupcake pans generally comprise removable forms that are insertable into the recesses of cupcake pans to create two or more compartments, which are then filled with different mixtures prior to baking. What is lacking in the prior art is a cupcake pan assembly that is insertable into a recess of a cupcake pan to alter a shape of the recess prior to adding a mixture to be baked.

### BRIEF SUMMARY OF THE INVENTION

An embodiment of the disclosure meets the needs presented above by generally comprising a tray and a plurality of molds. A plurality of holes is positioned in the tray. Each mold comprises a disc in which a recess is positioned. Each recess has a respective shape so that the plurality of molds comprises recesses having a variety of shapes. A lip, which extends radially from the disc, is complementary to a perimeter of a respective hole. The mold is removably engageable to the tray upon insertion into the respective hole. The recess is configured for addition of a baking mixture so that a baked good shaped complementarily to the recess is obtained upon baking of the baking mixture.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a shape generating cupcake pan assembly according to an embodiment of the disclosure.

FIG. 2 is an exploded view of an embodiment of the disclosure.

FIG. 3 is a detail view of an embodiment of the disclosure.

FIG. 4 is a front view of an embodiment of the disclosure.

FIG. 5 is a cross-sectional view of an embodiment of the disclosure.

FIG. 6 is a flow diagram for a method utilizing an embodiment of the disclosure.

### DETAILED DESCRIPTION OF THE INVENTION

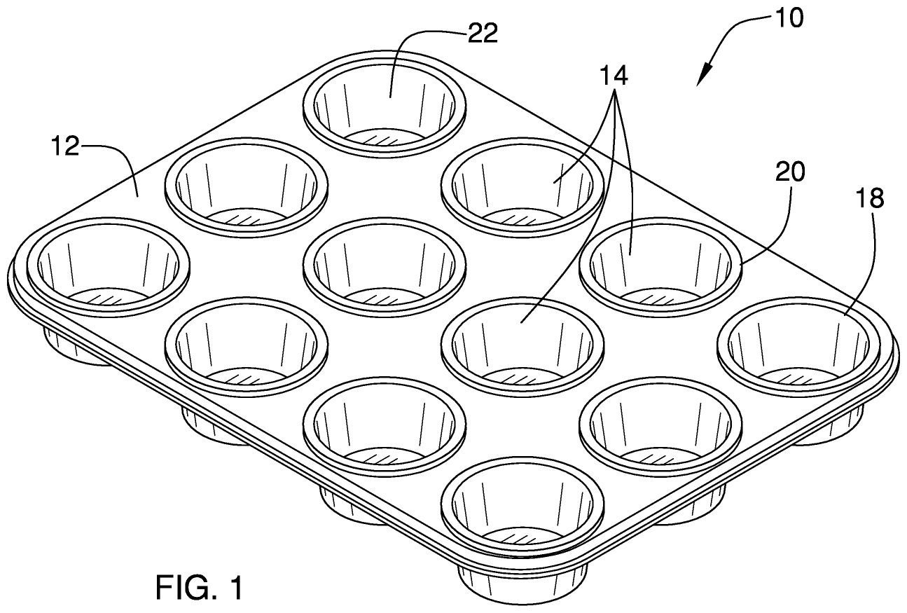

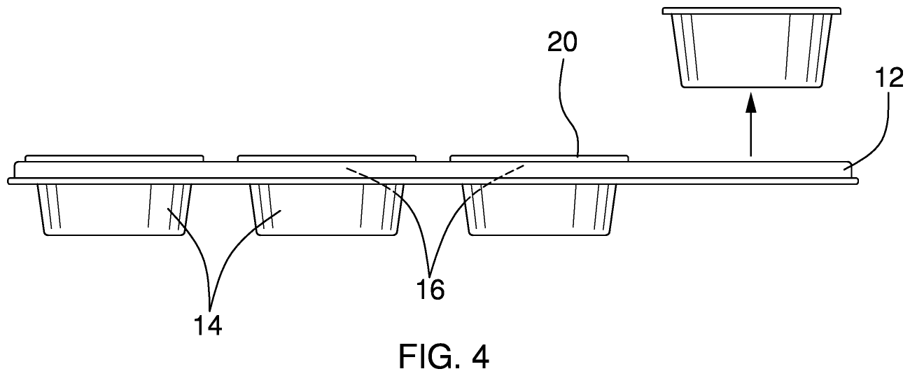

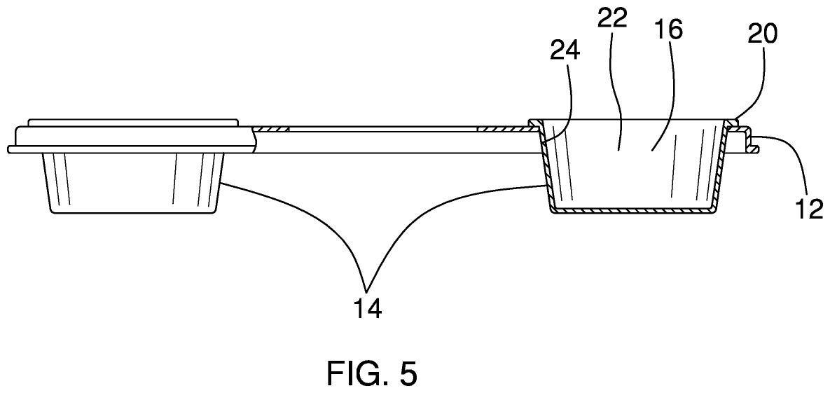

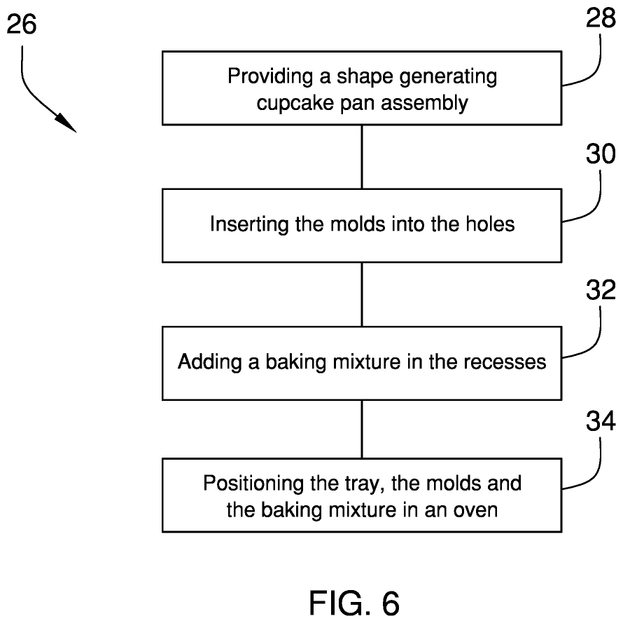

With reference now to the drawings, and in particular to FIGS. 1 through 6 thereof, a new cupcake pan assembly embodying the principles and concepts of an embodiment of the disclosure and generally designated by the reference numeral 10 will be described.

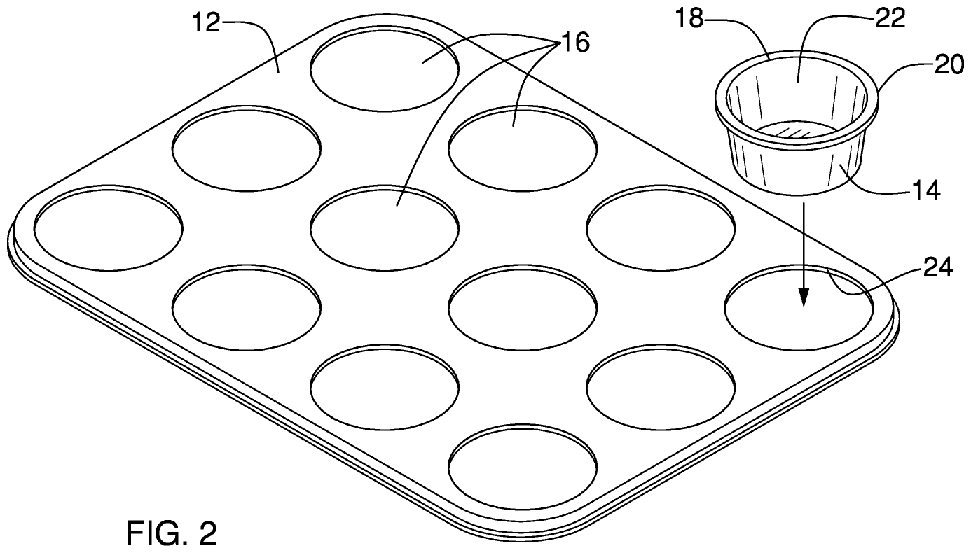

As best illustrated in FIGS. 1 through 6, the shape generating cupcake pan assembly 10 generally comprises a tray 12 and a plurality of molds 14. A plurality of holes 16 is positioned in the tray 12, which may be rectangular, as shown in FIG. 2, circular, or the like. The holes 16, as shown in FIG. 2, are circular, although the present invention also anticipates holes 16 that are square, triangular, and the like.

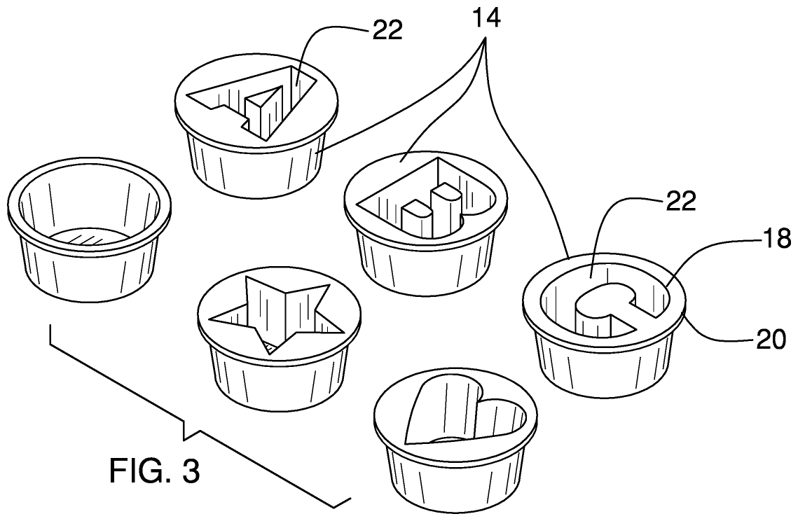

Each mold 14 comprises a disc 18 from which a lip 20 extends radially. A recess 22 is positioned in the disc 18. The lip 20 is complementary to a perimeter 24 of a respective hole 16 so that the mold 14 is removably engageable to the tray 12 upon insertion into the respective hole 16. The mold 14 enters into a snap fit relationship with the tray 12 upon insertion into the respective hole 16. Each recess 22 has a respective shape so that the plurality of molds 14 comprises recesses 22 having a variety of shapes, such as, but not limited to, shapes of letters, hearts, clovers, stars, and the like, examples of which are shown in FIG. 3.

The recess 22 is configured for addition of a baking mixture so that a baked good, which is shaped complementarily to the recess 22, is obtained upon baking of the baking mixture. The tray 12 and the molds 14 may comprise polytetrafluoroethylene, ceramic, or the like, so that the baked goods do not stick to the tray 12 and the molds 14.

The shape generating cupcake pan assembly 10 enables a method 26 for creating baked goods having a plurality of shapes. The method 26 comprises a first step 28 of providing a shape generating cupcake pan assembly 10 according to the specification above. A second step 30 of the method 26 is inserting the molds 14 into the holes 16. A third step 32 of the method 26 is adding a baking mixture in the recesses 22. A fourth step 34 of the method 26 is positioning the tray 12, the molds 14, and the baking mixture in an oven. The present invention is anticipated to reduce the number of baking pans required for a baker to produce baked goods having a wide variety of shapes.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shape generating cupcake pan assembly comprising:
a tray in which a plurality of holes is positioned; and
a plurality of molds, each mold comprising:
a disc in which a recess is positioned, each recess having a respective shape, such that the plurality of molds comprises recesses having a variety of shapes, and
a lip extending radially from the disc, the lip being complementary to a perimeter of a respective hole, such that the mold is removably engageable to the tray upon insertion into the respective hole, wherein the recess is configured for addition of a baking mixture, such that a baked good shaped complementarily to the recess is obtained upon baking of the baking mixture.

2. The shape generating cupcake pan assembly of claim 1, wherein the holes are circular.

3. The shape generating cupcake pan assembly of claim 1, wherein the mold enters into a snap fit relationship with the tray upon insertion into the respective hole.

4. The shape generating cupcake pan assembly of claim 1, wherein the tray and the molds comprise polytetrafluoroethylene or ceramic, such that the baked goods do not stick to the tray and the molds.

5. A method for creating baked goods having a plurality of shapes, the method comprising the steps of:
providing a shape generating cupcake pan assembly comprising:
a tray in which a plurality of holes is positioned, and
a plurality of molds, each mold comprising:
a disc in which a recess is positioned, each recess having a respective shape, such that the plurality of molds comprises recesses having a variety of shapes, and
a lip extending radially from the disc, the lip being complementary to a perimeter of a respective hole, such that the mold is removably engageable to the tray upon insertion into the respective hole, wherein the recess is configured for addition of a baking mixture, such that a baked good shaped complementarily to the recess is obtained upon baking of the baking mixture;
inserting the molds into the holes;
adding a baking mixture in the recesses; and
positioning the tray, the molds, and the baking mixture in an oven.

6. The method claim 5, wherein the holes are circular.

7. The method claim 5, wherein the mold enters into a snap fit relationship with the tray upon insertion into the respective hole.

8. The method claim 5, wherein the tray and the molds comprise polytetrafluoroethylene or ceramic, such that the baked goods do not stick to the tray and the molds.

9. A shape generating cupcake pan assembly comprising:
a tray in which a plurality of holes is positioned, the holes being circular;
a plurality of molds, each mold comprising:
a disc in which a recess is positioned, each recess having a respective shape, such that the plurality of molds comprises recesses having a variety of shapes, and
a lip extending radially from the disc, the lip being complementary to a perimeter of a respective hole, such that the mold is removably engageable to the tray upon insertion into the respective hole, wherein the recess is configured for addition of a baking mixture, such that a baked good shaped complementarily to the recess is obtained upon baking of the baking mixture, the mold entering into a snap fit relationship with the tray upon insertion into the respective hole; and
the tray and the molds comprising polytetrafluoroethylene or ceramic, such that the baked goods do not stick to the tray and the molds.
